(19) United States
(12) Patent Application Publication
(10) Pub. No.: US 2020/0363005 A1
(43) Pub. Date: Nov. 19, 2020

(54) 3D SHAPED ASSEMBLY

(71) Applicant: Hutchinson, Paris (FR)

(72) Inventors: Fabrice Chopard, Saint-Martin-d'Hères (FR); Cédric Huillet, Montargis (FR)

(73) Assignee: Hutchinson, Paris (FR)

(21) Appl. No.: 16/640,633

(22) PCT Filed: Aug. 22, 2018
(86) PCT No.: PCT/FR2018/052094

§ 371 Date: Feb. 20, 2020

(30) Foreign Application Priority Data
Aug. 22, 2017 (FR) 1757792

(51) Int. Cl. F16L 59/02; B32B 5/02; B32B 1/00; B32B 5/14; B32B 3/26; B32B 3/30; B32B 5/26; B32B 27/12; B32B 15/20; B32B 27/16; B32B 15/09; B29C 51/14; F28D 20/02

(52) U.S. Cl. CPC F16L 59/026; B29L 2031/3014; B32B 1/00; B32B 5/145; B32B 3/263; B32B 3/30; B32B 5/26; B32B 27/12; B32B 15/20; B32B 27/16; B32B 15/09; B29C 51/145; F28D 20/023; B32B 2307/304; B32B 2605/08; B32B 2605/10; B32B 2605/12; B32B 2605/18; B32B 2307/102; B32B 2307/738; B32B 2250/40; B32B 2307/72; B29C 2791/006; B32B 5/022

(57) ABSTRACT

A three-dimensionally shaped assembly comprising fibres in a three-dimensional structure, and a sleeve comprising a polymeric film and which encloses the fibrous structure, the shape of which is followed by the polymeric film.

This application is a national phase of PCT/FR2018/052094 filed Aug. 22, 2018, which claims priority to French Patent Application No. 1757792, filed Aug. 22, 2017, the entirety of each of which are incorporated by reference herein.

The present invention relates to a three-dimensionally shaped assembly.

Many lining elements, typically an inner lining, such as in a vehicle such as an aircraft, ship, train or automobile, are already used for protection purposes, typically thermal and/or acoustic protection, or as a fire barrier element.

However, for this type of elements, which are typically moulded, problems still exist both in terms of structural design and conditions of use. Thus, for example, there are elements comprising compounds in powdered and/or fibrous form, which raises problems of dispersion and/or handling. Structural problems can also arise, for example, in the context of compromises to be made between protection requirements (e.g. thermal and/or acoustic and/or fire barrier requirements as mentioned above) on the one hand and volume and/or weight requirements on the other hand, especially when mounting in cramped and/or hard-to-reach locations. Special shape requirements may also be established.

For example, in an automobile, the floor and walls connecting the passenger compartment to the trunk space and the passenger compartment to the engine space are lined with insulating moulded parts. These moulded parts must be adapted to sometimes complex, irregular frame parts in terms of mechanical strength and/or protective capacity.

Some three-dimensional moulded parts, e.g. for sound insulation, can be produced from PU foam (polyurethane). However, this is relatively expensive. In addition, PU foam is also difficult to recycle. Moulded parts made from conventional fibre mats, which are manufactured from fibrous materials by rollers, are only suitable to a limited extent. Fibre mats can only be used for slightly deformed parts. Furthermore, due to the rolling method, they do not have a uniform density distribution. As a result, they often do not meet the geometric and acoustic requirements imposed on these special casting parts.

It is within this framework, and in order to provide a solution adaptable to different demanding environments, that a three-dimensional assembly is proposed here, the assembly comprising:

a woven or non-woven three-dimensional (3D) fibrous textile structure comprising polymeric, mineral or natural fibrous fibres, and

a closed sleeve comprising a wall and in which is (thus) enclosed the fibrous textile structure, the shape which is followed by the wall.

The term fibres is to be understood in a conventional way. These are elongated elements having a length L (which corresponds to its largest dimension) and, transverse to this length, a section where the fibre has a main dimension d (such as a width or diameter), with a ratio such that L≥5d, and preferably L≥10d. There may be one or more type(s) of fibres (such as glass fibres and others).

The textile nature of the fibrous textile structure provides a structuring effect, resulting in a fairly light assembly that can be very varied in shape.

The sleeve comprising the polymeric film is used as a protection (no direct contact with the fibres whose dispersion is prevented, nor with the fibrous textile structure, which is also protected). The film can also facilitate handling and storage.

If said wall of the closed sleeve comprises (or consists of) a thermoformed polymeric film (polymer alone or metal-lined), a thermoformed assembly will be obtained, the shape of which may have been defined with perhaps greater precision, or even possibilities, than with a metal (steel or aluminium, for example) wall, in terms of the curved shape and/or the reliefs (21 below) and/or the recesses (23 below) which may be desired.

If a thermoformable polymeric film is used, in accordance with its conventional definition, this sleeve will therefore be a flexible object whose shape (like its material: the film) and that of the fibrous textile structure it surrounds will match each other. A synonym is then: bag or pocket.

Of course, in all cases the sleeve will surround and completely cover the fibrous textile structure.

The fibres contained in a three-dimensional (i.e. non-planar) fibrous textile structure may or may not be bound together by a binder (chemical implication). In the second case, it is favourably provided:

that the fibrous textile structure is therefore free of a binder to thereby bind said fibres together, and,

that said wall of the sleeve has a non-planar shape (curved shape and/or with reliefs and/or with recesses) which imposes its shape on the textile fibrous structure, so that the sleeve maintains said shape of the fibrous structure.

In particular with a thermoformed polymeric film, the combination between the wall of the sleeve and the fibrous textile structure will make it possible both to achieve and to maintain over time a 3D shape that is both light, with interesting thermal and/or acoustic characteristics, and even mechanically solid, depending on the density or densities of the fibres retained.

In this respect, it is recommended that said wall should have a breaking strength greater than 1 MPa, and preferably between 10 MPa and 300 MPa.

Thus, in particular in the absence of a binder between fibres, both in the form and a fortiori as a thicker and more rigid wall (metal), said wall will be able to impose the expected 3D shape on the fibrous textile structure, forcing it to deform in relation to its initial rough shape, typically a 2D shape.

In this respect, it is also recommended that the fibre density in the sleeve (without binder) should then range between 5 kg/m³ and 250 kg/m³ and preferably between 50 kg/m³ and 130 kg/m³. The density of the fibrous textile structure will then range between 10 kg/m³ and 300 kg/m³ and preferably between 60 kg/m³ and 150 kg/m³.

In addition, if said wall of the sleeve is a film with a thickness of less than 500 microns, it is recommended that the assembly obtained has a maximum thickness of less than or equal to 8 mm and preferably less than 3 mm. Thus, it will be possible to combine the fineness of a final thermoformed assembly with high mechanical strength after thermoforming.

To complete the compromise of lightness/structuring/ease of manufacture/possible functionalization(s) within the sleeve, it is however also proposed that the fibrous textile structure may include a binder, so that a matrix is shaped in which said fibres will be bonded together at their contact or crossing points. But this is not compulsory. Both hypotheses are discussed in greater detail below.

If present, and for the same purpose as above, the binder will preferably comprise a glue and/or an adhesive.

In addition, such an assembly is easily suitable for targeted functional applications, in particular due to the structuring provided by the fibrous structure.

It is therefore proposed that said assembly may additionally comprise, in the sleeve, a thermal insulator, so that at ambient temperature and pressure, the thermoformed assembly has, through the polymeric film, a coefficient of thermal conductivity A of less than 40 mW/m·K.

In the application, the ambient temperature and pressure mean 20° C. and 10⁵ Pa, respectively, to within 10%.

In particular, with the solution developed here, it will be possible for the thermal insulator (such as an aerogel) to be arranged in the sleeve, in the fibrous textile structure. This makes it easier and cheaper to obtain the thermoformed assembly, while allowing a wide variety of shapes and different protective effects, depending on the concentration chosen. The binder will then be able to freeze and hold the thermal insulator in place.

Another relevant functionalization approach is that which provides that said wall of the sleeve is airtight, that this sleeve is closed in an airtight manner, and that at outside ambient temperature (20° C.) and pressure (10⁵ Pa), a pressure ranging between less than 10⁵ Pa and more than 10⁻² Pa prevails therein.

The polymeric film will then be used for another effect, increasing the thermal protection effect of said assembly, due to the recess created in the sleeve.

In the same context, (at least) one phase change material (PCM) being included in the sleeve may be relevant.

And, as with the thermal insulator, it will be possible for this phase-change material to be dispersed in the sleeve, within the fibrous structure, with the advantages already mentioned.

The combined use of such components—fibres on the one hand and dispersed particles for the PCM(s) and/or the thermal insulator on the other hand—will make it possible to obtain, in an industrially feasible way in series, a variable concentration of these components which the binder will fix and unite. Once the density distributions of the components have been made, and as soon as the fibres and the binder are everywhere on the finished part, it will suffice, with a thermoformable film wall, to heat everything in the shaping mould where all the components will then have been placed, for the fibres to melt together, the binder joining all the components together by polymerisation, while complying with the variable concentration chosen. Solidification into a rigid moulded part can then be achieved by curing or polymerisation.

With an overall construction as above, and whether or not thermal insulator and/or MCP is/are present, said assembly will favourably have a thickness between 0.8 and 20 mm, and a density between 5 and 350 Kg/m³, to within 5%.

With these characteristics, an absorption coefficient as a function of frequency ranging between 60 and 90% for an excitation frequency of said assembly ranging between 2000 and 4000 Hz is expected. Preferably, the pore volume (void space) will range between 80 and 99% (by volume).

With or without a binder, another aspect provides that the invention makes it possible to adapt said assembly to its operational environment, and in particular to obtain:

that said assembly has first zones with a first thickness and second zones with a second thickness less than the first thickness,

and that the second zones then have a higher fibre density than the fibre density of the first zones.

Thus, it is easy to vary the thermal conductivity and/or mechanical strength in the thickness direction, albeit to a limited extent, but without necessarily having to add fillers in the textile structure (MCP or thermal insulating material such as an aerogel; see below). Other advantage: improvement of acoustic properties due to densification or not; if dense: absorption of low frequencies, if sparse: absorption of high frequencies.

The invention will be better understood, if need be, and other details, characteristics and advantages of the invention will appear upon reading the following description given by way of a non restrictive example while referring to the appended drawings wherein:

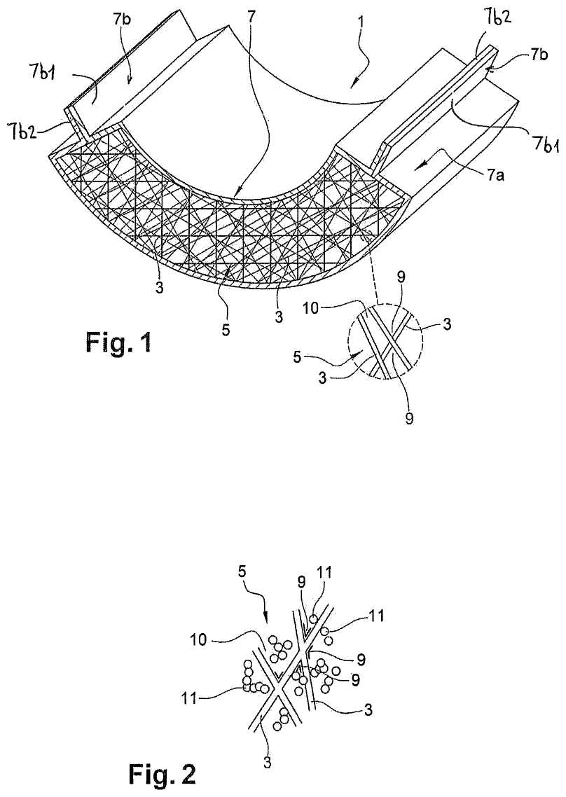

FIG. 1 is a sectional view of a section of a part corresponding to the above-mentioned assembly according to the invention, this view being supplemented by a local enlargement;

FIG. 2 corresponds to the local enlargement of FIG. 1, but with the addition of thermal insulator particles dispersed between the fibres in the fibrous structure;

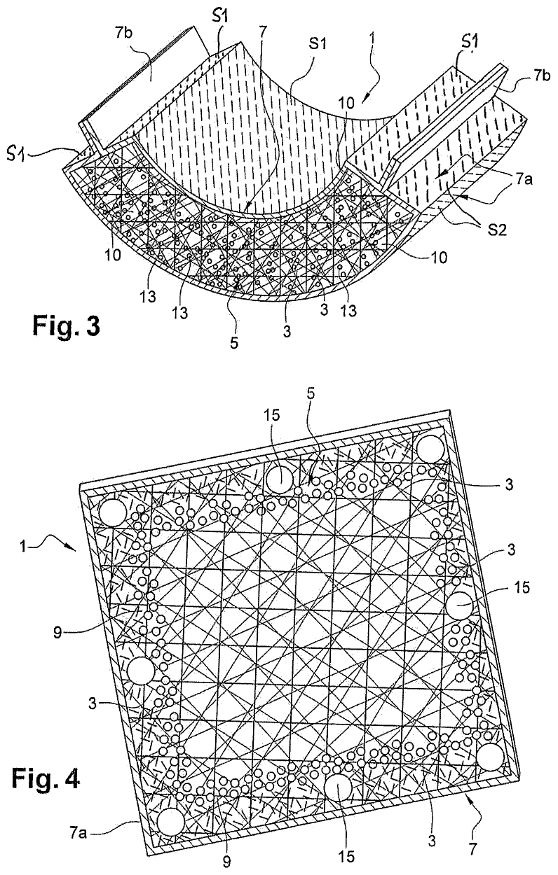

FIG. 3 corresponds to the cut section of FIG. 1, this time with the addition of PCM particles dispersed in the fibrous structure;

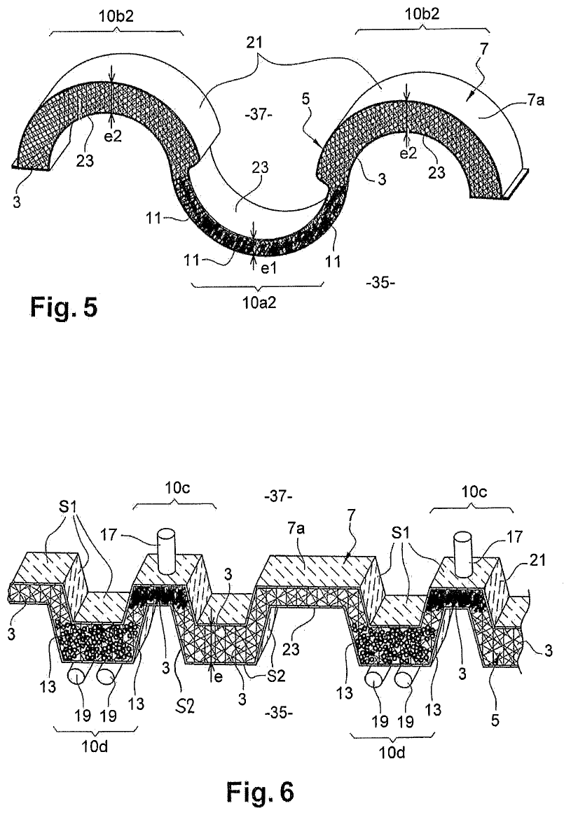

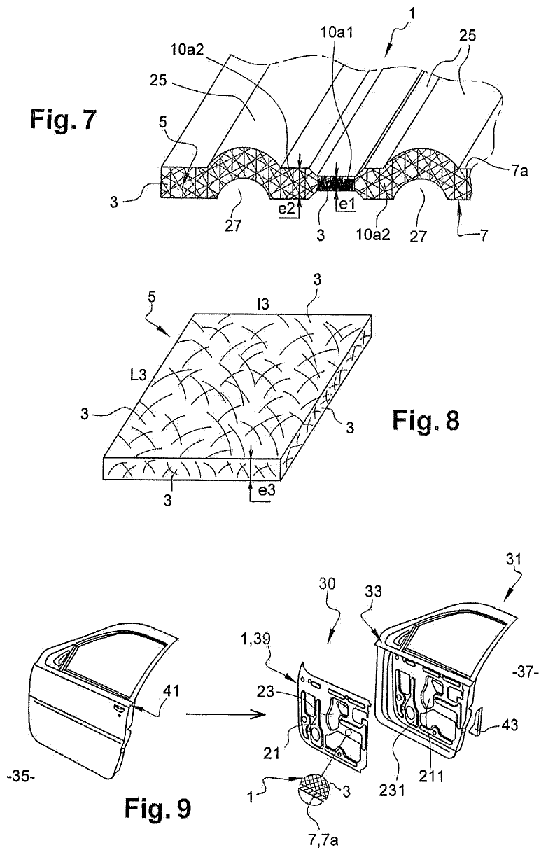

FIG. 4 is also a planar section of a part corresponding to the above-mentioned assembly according to the invention, with an over-densification of reinforcing fibres at the periphery, likewise for the sections of FIGS. 5 and 6 where the illustrated assembly, according to the invention, is however either provided with local over-densification of heat insulation particles (FIG. 5) and MCP (FIG. 6), respectively, dispersed in the fibrous structure, the identical section of FIG. 7 corresponding to a fibrous structure without a binder,

FIG. 8 shows an example of a raw fibrous textile structure, in a binderless hypothesis, as it is used when it is placed in the shaping mould,

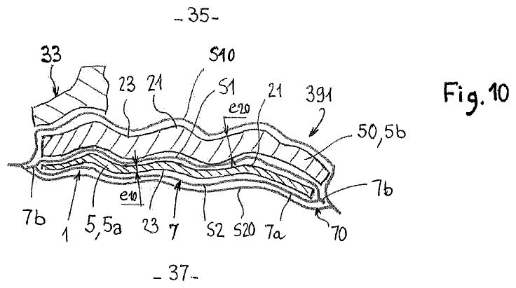

FIG. 9 shows an automobile door application, and FIG. 10 shows an assembly (in cross-section) with enhanced thermal and acoustical capabilities, double pocket-in-pocket and double layer of insulation.

A three-dimensional thermoformed assembly 1 is shown in FIG. 1.

This assembly includes:

a three-dimensional fibrous textile structure 5 comprising fibres 3, and

an outer sleeve 7 comprising (or consisting of) a wall 7a.

It will have been understood that the expression “three-dimensional” (3D) is equivalent, as in the common sense, to not (entirely) planar. The thermoformed assembly 1, like thus the fibrous textile structure 5, is represented curved; but they could also have common local reliefs and/or recesses, as for example in zones 25, 27 in FIG. 7, or in FIGS. 5,6 (zones 21,23). These recesses and reliefs (or bumps) can be referred to as “embossing”.

The fibrous textile structure 5 is a woven or non-woven fabric. A felt will be interesting a priori.

Felt is a non-woven structure obtained by pressing and bundling fibres.

The felt, or more generally the fibrous textile structure 5, can be presented as a plate (see FIG. 8: e<<I<L) or a block (e<I<L). The shape will typically be 2D (flat). There may be several parts side by side or superimposed. A chemical binder is not required (solution in FIG. 8).

The wall 7a can be a metal wall of a few tenths of mm thick, or can be thermoformable, in the sense that it then comprises a polymeric film (or a complex or composite film, such as in particular polymer and metal: metallized

PET film where a PET film has been sprayed with aluminium) which has been thermoformed.

In the second case, the polymeric film 7a will have been thermoformed at the location of the two major (or main) surfaces, S1 and S2 FIG. 3 or 6 (surfaces opposite each other, in dashed lines), between which the fibrous textile structure 5, which is three-dimensional, has a curved shape and/or reliefs 21 and/or recesses 23. This thermoforming of the polymeric film 7a will therefore not have been limited, as in a 2D flat part, to the minor/marginal peripheral area in terms of surface area (areas 7b FIGS. 1,3 since these are cuts) where there is interbonding of the sheets forming the film 7a and where these sheets are sealed together, typically heat-welded, to close the sleeve.

The sleeve 7 contains the fibrous structure 5 in a closed manner; and its wall 7a follows (or marries) the shape of this fibrous structure where it faces it (major surfaces S1 and S2).

Sealing on itself, e.g. by welding or gluing, wall 7a—which can comprise two sheets—, once the fibrous structure 5 is thus surrounded, will allow the sleeve 7 to be closed. Indeed, to make the assembly 1 for example with a thermoformable polymeric film 7a, one could typically:

start from a “basic” fibrous structure 5 a priori shaped therefore as at least one block, or a plate (see FIG. 8: flat shape, 2D: without relief or recess),

then place the block(s)/plate(s):
or between two sections of said polymeric film 7a,
or in an open pocket made of this film 7a, where it (they) will have been slipped,

then have:
said polymeric film sections 7a sealed together,
or the opening of the pocket sealed,
   This sealing may have been carried out during the thermoforming (via the heat released), or independently, a priori prior to the thermoforming.

As shown in FIG. 8, the plate will differ from the block in that there is then a ratio of at least five between the thickness e3 and the length L3 and width 13.

As mentioned above, the sealing of the wall 7a on itself could have consisted in gluing or welding.

This confirms that, in the three-dimensionally shaped assembly 1, the fibrous textile structure 5 and the sleeve 7 retain, as initially, their respective structural identities. They're not merged. They remain distinctly identifiable; they are structurally independent of each other: It is possible to cut the sleeve 7 and remove it from its position around the fibrous structure 5 without having to tear it off. It is therefore not a coating or surface layer (coating as in U.S. Pat. No. 4,035,215).

In the case of a “film”, the material 7a will have a favourable thickness between 30 and 800 microns, preferably between 30 and 450 microns and even more preferably between 50 and 150 microns.

In the fibrous textile structure 5, fibres other than polymeric ones: mineral (e.g. glass, basalt) or natural fibres (e.g. cellulose, flax, hemp) may be used. In the first hypothesis, the fibres 3 will not be bonded together by a compound forming a (chemical) binder. Without a binder to bind them together (see below and FIG. 8, in a raw form of the product, before wrapping in a sleeve and thermoforming), the fibres 3 are nevertheless bound by the textile nature of the structure 5 they form.

If this structure 5 is a felt, its non-woven nature ensures the cohesion of the fibres, which are then bonded together, for example by blowing and pressurising, with possible scalding, in the initial raw form, which will a priori be a 2D form. In this case, it is recommended that the assembly 1 has a maximum thickness less than or equal to 20 mm, preferably 8 mm and preferably 3 mm. And if a thermoformed polymeric film 7a is used, it is recommended that it then has such tensile strength that the desired integrity of the 3D shape is maintained.

This tensile strength (“tensile strength”, often abbreviated as (TS), or “ultimate strength”, Ftu) of a typical film 7a, whether in a version after the above-mentioned thermoforming step or before same (the state of this film as marketed before its use in accordance with the present invention), will be favourably greater than 1 MPa, and preferably between 10 MPa and 300 MPa and even more preferably between 50 MPa and 100 MPa.

If these characteristics are not respected, the relatively free nature of the fibres 3 and the mechanical strength of the sleeve 7, whose thermoforming will therefore have fixed a common “3D” shape by stressing the fibres and softening the film 7a, will not be able to ensure that the thermoformed assembly 1 maintains its 3D shape over time:

following the release of stress after thermoforming, and without a binder, the fibres of the textile structure 5 will tend to return to their initial state (shape in particular) before thermoforming,

and the sleeve film won't be able to prevent that.

Hence a possible preference for a slightly thicker metal wall 7a.

As will be seen below also in connection with FIG. 6, it is also possible with such characteristics to obtain that the formed assembly 1 has first zones 10a1 with a first thickness e1 and second zones 10b1 with a second thickness e2 which is greater than the first thickness e1 (e1<e2), with the first zones 10a1 having a fibre density 3 greater than the fibre density 3 of the second zones 10b1; see FIG. 7 where, if the maximum thickness is assumed to be e2, we will have e2≤8 mm and preferably e2≤3 mm).

If the fibrous structure 5 comprises fibres without a binder 9, the respective fibre densities 3 in the first zones 10a1 and the second zones 10b1 will each be uniform (equal) over all the respective thicknesses e1,e2. These variations in density between the zones such as 10a1, 10b1 can be achieved by starting from different thicknesses of these zones from each other (e1+X and e2+X respectively). The generally uniform compression on the outer surface of the fibrous structure 5, created during the thermoforming of the film 7a if so chosen, will achieve the above-mentioned thicknesses e1 and e2 respectively.

The (higher) fibre density 3 of the zones 10a1 (see also zone 10c FIG. 6) will be favourably above 300 kg/m³, and preferably above 450 kg/m³. The lower level in the zones 10b1 (see outside zones 10c FIG. 6) will be favourably below 150 kg/m³, and preferably between less than 100 kg/m³ and 30 kg/m³.

In the second hypothesis, it is therefore possible that a filler binder 9 is present in the fibrous structure 5, so that the fibres 3 are bonded together in this way, as in the examples in FIGS. 1 to 4.

The fibres 3 then adhere to each other at their zones or points of contact. The manufacturing technique can be that of EP-A-2903800, a fibrous structure and a manufacturing process being known from documents DE 103 24 735 and DE 10 2007 054424. As a binder 9, a glue and/or an adhesive, such as epoxy or a phenolic resin, can be used. A thermosetting resin acting by bonding or adhesion was noted as suitable.

It can then be provided that the shaped assembly 1 has a maximum thickness e,e2,e3 greater than 3 mm. The binder 9 participates both in the shaping of the fibrous textile structure 5 (during the thermoforming) and in maintaining the integrity of its shape over time.

When using a heat-reactive binder 9 such as, for example, plastic fibres such as polypropylene or a phenolic resin, the fibres are heated in such a way that they melt and agglomerate with one another and a rigid, dimensionally stable moulded part is shaped.

With an assembly as above, a suitable rigid moulded part 1 can be achieved with an accuracy of 5%:

a thickness between 2 and 10 mm,

a density between 5 and 350 Kg/m³,

and an absorption coefficient as a function of frequency between 60 and 90% for a frequency between 2000 and 4000 Hz.

Thus, this room will be acoustically efficient and can be used for sound insulation.

In order to follow the shape of the fibrous structure 5, the wall 7a of the sleeve 7 will therefore, with or without a binder 9, be shaped (thermoformed in the case of the above-mentioned polymeric film) around the fibrous structure 5.

With or without a fibre binder 9 between the fibres, forming can take place, in a conventional way, in a shaping mould: the material of the raw structure 5, in a priori 2D form (plate or block in particular; in one or more pieces), is heated to soften. So is the film 7a if one is used. This ductility is used to shape the wall 7a and the material of the structure 5 under pressure by casting. The film 7a and the film 7a will stiffen as it cools, if used). With the material of the structure 5, it retains the 3D shape achieved, due either to the binder 9, in particular or to the above-mentioned parameters (the structure thickness 5 and the wall strength 7a).

If the polymeric film 7a option is chosen, it can be a polyimide or PEEK, or polyethylene, or polypropylene film.

It will therefore be a thermoplastic or thermoset film.

which will be thin enough (hence the term “film”) to melt and soften sufficiently under the action of heat to be able, with the fibres 3 which it will then surround due to its prior conformation in a closed pocket, to be shaped on a mould, and thus impose on the fibrous structure 5 the expected 3D shape (in volume) (as in the present case, curved shape and/or reliefs 21 and/or recesses 23),

while being sufficiently thick (in fact sufficiently solid) to maintain over time (years) said shape imposed by its thermoforming, preventing the fibrous structure 5 from losing the 3D shape achieved, even in the absence of a binder 9; hence the aforementioned tensile strength.

With the above-mentioned fibrous structure 5, and since, if a binder 9 is present, it will only be present at the junction areas between the components, a part 1 where the empty spaces 10 between the fibres will ensure a thermal insulator effect will be obtained from the outset.

To the above assembly, it will however be possible (and while maintaining this effect) to usefully add, in the sleeve 7, at least one thermal insulator 11, so that at ambient temperature and pressure, the thermoformed assembly has, through the polymeric film 7a, a coefficient of thermal conductivity A of less than 40 mW/m·K, and preferably between 18 and 25 mW/m·K; see FIG. 2.

In addition, with the protective wall 7a, the thermal insulator 11 can then be usefully dispersed in the fibrous structure 5.

With a thermal insulator 11 in the form of particles, the binder 9 can locally ensure cohesion, if present. And a variable concentration according to needs can be achieved.

This is also possible if the assembly 1 additionally contains at least one phase change material (PCM) in the sleeve 7, which can therefore also be dispersed in the fibrous structure 5.

If MCP is in particle form 13 (FIG. 3), its processing and behaviour within the fibrous structure 5 may be the same as that of a powdered thermal insulator.

And, due to the advantageously thermoformed sleeve wall 7a, which follows the shape of the fibrous structure 5 by enclosing it, protection will be provided:

a mechanical protection (a function of shaping and then holding, and furthermore direct contact between the fibrous structure 5 and the external environment is avoided, as well as diffusion of powder(s) out of the fibrous structure),

anti-agglomerate (so long as the sleeve wall 7a does not “float” around the fibrous structure 5, the undesired formation of powdery lumps consisting of MCP particles 13 and/or thermal insulator 11 is avoided),

and/or a chemical protection (a fire protection function of the sleeve wall 7a possible).

If an air-tight wall 7a is used, then the assembly 1 can be very tightly sealed (typically heat-welded in the zones 7b of the interlayer of the sheets forming the wall 7a) so that, at the ambient outside temperature and pressure, a pressure ranging between less than 10⁵ Pa and more than 10⁻² Pa prevails in the sleeve 7.

Using a partial vacuum will enhance both the effects of insulating and maintaining the dispersion of the particles 11 and 13 in the fibrous structure 5.

FIGS. 4-6 show privileged, operational examples of variable densification/dispersions of the fibres 3 and the particles 11 and/or 13, in the fibrous textile structure 5, under the sleeve 7, all of which can be held together and placed, at the contact areas, by the local binder 9 which, as can be seen, does not occupy all the space left by the fibres and the other components.

In the example in FIG. 4, the fibrous textile structure 5 includes, peripherally, an overdensification or an overconcentration of fibres 3 and (particles of) MCP 13. Fibre overdensification 3 is located around the fixing zones of the part 1 corresponding to the through-passages (circles), some of which are referenced 15. This overdensification may be the result of an initial higher fibre dosage in some areas than in others. It can also result from greater compression in some areas than in others.

In the example in FIG. 5, the fibrous structure 5 of the part 1 is thinner in the part 10a2 (thickness e1) than it is in the part 10b2 (thickness e2). It is the finer part 10a2 that there is an over-densification or over-concentration of (particles of) thermal insulator 11, to compensate for the smaller thickness and to keep a homogeneous thermal conductivity.

In the example of FIG. 6, the fibrous textile structure 5 of the part 1 is overfilled with fibres 3 (thus increased fibre density) in zones 10c, where the part can be fixed via for example rods 17 and where the part has corners, thus areas of potential mechanical weakness. Like the zones 15, those 10c define integrated zones of reinforcement or mechanical structuring, without the need for external reinforcement.

In the zone(s) 10d the fibrous structure 5 is (over)loaded with MCP (particles) 13, where the part 1 has (a) heat exchange zone(s) with a refrigerant or heat transfer fluid 19.

In this way, it is possible to precisely and appropriately locate the areas of (over)densification or (over)concentration of particles and/or fibres where they are needed.

As already mentioned, a notable field of application of the invention is that of vehicles. The three-dimensionally shaped assembly 1 can in particular define therein an inner lining element of a structural element, said structural element separating between them an external environment and an internal volume to be thermally and/or acoustically insulated or protected from this external environment. The inner lining element can also form a fire barrier, as mentioned above, with the constraints of a small volume, particular shapes and/or weight to be limited as much as possible.

So FIG. 9 shows an example of an assembly 30 in a vehicle 31 (here a car, but it could be an aircraft, especially an aircraft cabin). This assembly includes:

a structural element 33 interposed between an external environment (EXT; 35) and an internal volume (INT; 37) of the vehicle, this internal volume (typically the passenger compartment of the vehicle) having to be thermally and/or acoustically protected from the external environment (35), and

an inner lining element 39 of structural element 33, the inner lining element comprising a said assembly 1.

The lining element 33 is therefore interposed between the volumes 35 and 37.

The structural element 33 can be a metal, composite or plastic door panel. In the example, it defines the structural framework of a car door. On the exterior side, a door panel 41 can be attached to it, which defines the exterior trim of the door. On the interior side, an interior trim 43 (on the passenger compartment side) can be attached to it, so that the assembly 1 is interposed between the sheet metal 41 and the interior trim 43.

In the totally enclosed sleeve 7 of this assembly 1 are located, as shown in FIGS. 5,6 (which can be considered as two respective cuts, in the thickness direction, at two different places of the surface defined by the assembly 1, see hatching FIG. 9):

at least one priority area 10d where a heat exchange to be controlled between the external environment 35 and the internal volume 37 has been identified,

and/or at least one zone (10a) of lesser thickness (e1),

and/or fixing zone(s) 10c, where the assembly 1 is attached to the structure 33.

These fastenings to the structural element 33 may include screwing, riveting or other means, e.g. by means of rods 17.

And the sleeve 7 will then contain at least one of the following in addition:

a filler of (particles of) a phase change material (PCM) 13 and/or a filler of (particles of) a thermal insulator 11, where said preferred heat exchange zone(s) 10d is/are located,

and/or an overfill of said fibre 3, where the fixing zone(s) and/or where the zone(s) of lesser thickness e1 is/are located.

Rather than, as shown in FIG. 6, where a filler of (particles of) MCP 13 is therefore present in the sleeve 7 where the part 1 has one or more heat exchange zone(s) with a refrigerant or a heat transfer fluid 19, a filler or an overfill of said thermal insulator 11 (such as at least one layer of polyurethane, or polyester fibres dispersed in the fibrous textile structure), where the preferred heat exchange zone(s) 10d is/are located, i.e. where one or more zone(s) has/have been identified, in the direction of the thickness e of the sleeve 7, where the local thermal conductivity coefficient A is higher than a predefined threshold, between volumes 35 and 37.

It should also be understood that solutions that can be combined between the embodiments, as well as between the figures (such as the combinations of fibre 3, thermal insulator 11 and MCP 13 in FIGS. 5,6), are transferable from one embodiment to another and can thus be combined with each other.

Another aspect of performance has been schematized in FIG. 10. It is a solution where both thermal and acoustic problems will be dealt with in a refined way.

This solution proposes to obtain a reinforced thermal insulator and a relevant acoustic insulation, by associating:

with a structural element 33 thus separating an external environment 35 from an internal volume 37 to be thermally and/or acoustically protected,

an inner lining element 391 of the structural element 33, the element 391 comprising at least one said heat insulating element 1.

More precisely, it is first proposed to take up the above-mentioned assembly, thus with said at least one heat insulating element 1 comprising its fibrous textile structure 5 in its sleeve 7 formed by the barrier wall 7a. This wall 7 is always thermoformed at the location of said two major surfaces S1,S2 between which the fibrous textile structure 5, which is three-dimensional, thus has a curved shape and/or reliefs and/or recesses, as schematized.

However, this solution also provides:

that said fibrous textile structure 5 defines a first fibrous textile structure comprising a porous material 5a having a first density,

that the inner lining element 391 further comprises a second fibrous textile structure 50 comprising the same porous material 5a, or a different porous material 5b, having a second density.

The second density is lower than the first density, and the first textile structure 5 is superimposed with the second textile structure 50.

Superimposed here means that a double thickness is obtained: the cumulative thickness of the fibrous textile structures 5,50 between the zones 35 and 37. Stacking is not necessarily in a horizontal plane; it can be in a vertical plane, as in the example of a car door in FIG. 9. It should be noted in this respect that applications other than on a vehicle are possible; in the building industry for example.

With this in mind, it will be further noted:

that the second fibrous textile structure 50 has a curved shape and/or reliefs 21 and/or recesses 23, and

that the heat-insulating element 1 and the second fibrous textile structure 50 are:
enclosed together in a second sleeve 70 with a wall 70a,
and interposed between two major surfaces S10,S20 of said wall 70a, said wall 70a being thermoformed at the location of said two major surfaces S10,S20.

It should be understood that the two major surfaces S10,S20 are the image on the sleeve 70 and its wall 70a of the two major surfaces S1,S2 on the sleeve 7 and its wall 7a. The minor/marginal peripheral area in terms of surface, here image 70b of 7b, remains.

The second sleeve 70 is not necessarily under vacuum (vacuum packed). The second fibrous textile structure 50 can be in a third vacuum sleeve, which is then housed, together with the first sleeve 70, in the second sleeve 70.

Typically less compressed than the first fibrous textile structure 5, the second fibrous textile structure 50 will have a thickness e20 greater than the thickness e10 of the first fibrous textile structure 5, this being to be considered everywhere or over at least most of the greater of the surfaces of the two fibrous textile structures 5.50.

The thickness e20 can be from 3 to 15 mm. The thickness e10 can be from 0.5 to 2.5 mm. The first density can be from more than 300 to 800 kg/m³; the second density can be from 100 to less than 300 kg/m³.

The first fibrous textile structure 5 provides relevant thermal and acoustic insulation. The second fibrous textile structure 50 provides reinforced thermal insulator and more limited acoustic insulation. The result is a hybrid solution with a heavy (mass-effect) assembly that absorbs in the low frequencies (20 to 200 Hz).

1. A three-dimensionally shaped assembly, the assembly comprising:
a three-dimensional fibrous textile structure, woven or non-woven, comprising polymeric, mineral or natural fibres, and having a curved shape and/or reliefs and/or recesses; and
a closed sleeve:
comprising a wall, and
which encloses the fibrous textile structure, the shape of which is followed by the wall.

2. The assembly according to claim 1, wherein:
the fibrous textile structure is devoid of a binder to thereby bind said fibres together, and has a density ranging between 10 kg/m³ and 300 kg/m³ and preferably between 60 kg/m³ and 150 kg/m³, and
the wall has a non-planar, curved shape and/or a shape with reliefs and/or with recesses, which imposes the shape of the fibrous textile structure, so that the sleeve maintains the shape of the fibrous textile structure.

3. The assembly according to claim 2, wherein said wall has a breaking strength greater than 1 MPa, and preferably between 10 MPa and 300 MPa.

4. The assembly according to claim 1, wherein the fibrous textile structure comprises a felt.

5. The assembly according to claim 1, wherein the fibrous textile structure comprises a chemical binder, so that said fibres are bonded together thereby.

6. The assembly according to claim 5, wherein the chemical binder comprises a glue and/or an adhesive.

7. The assembly according to claim 1, wherein the wall of the closed sleeve comprises a thermoformed polymeric film.

8. The assembly according to claim 1, further comprising a thermal insulator in the sleeve.

9. The assembly according to claim 1, wherein said wall is airtight, the sleeve is airtightly sealed, and, for outside ambient temperature and pressure, a pressure between less than 10⁵ Pa and more than 10⁻² Pa prevails in the sleeve.

10. The assembly according to claim 1, further comprising a phase change material in the sleeve.

11. The assembly according to claim 8, wherein in the sleeve there is:
one or more heat exchange zones for heat exchange with a refrigerant or a heat transfer fluid, and/or one or more zones of lesser thickness, and/or one or more zones for fixing said assembly, and
an overfill of said phase change material where said one or more heat exchange zones are located, and/or
an overfill of said thermal insulator where said one or more zones of lesser thickness is/are located,
and/or, an overfill of said fibres where the one or more zones for fixing said assembly are located.

12. The assembly according to claim 1, which has first zones having a first thickness and second zones having a second thickness which is less than the first thickness, the second zones having a higher fibre density than the fibre density of the first zones.

13. An assembly including:
a structural element adapted to be interposed between an external environment and an internal volume to be thermally and/or acoustically protected from said external environment, and
an inner lining element of the structural element, the inner lining element comprising the assembly according to claim 1, with, in the sleeve:
one or more priority areas where a heat exchange to be controlled between the external environment and said internal volume has been identified,
and/or one or more zones of lesser thickness,
and/or one or more fixing zones, wherein said assembly is fixed to the structure, and
a filler of phase change material and/or a filler of thermal insulator, where said one or more priority areas are located,
and/or an overfill of said fibres where the one or more fixing zones and/or where said one or more zones of lesser thickness are located.

14. An assembly comprising:
a three-dimensional structural element, having a curved shape and/or reliefs and/or recesses, interposed between an external environment and an internal volume to be thermally and/or acoustically protected; and
and an inner lining element of the structural element, the inner lining element comprising at least one said assembly according to claim 1, which is thereby interposed between the external environment and the internal volume to be protected,
wherein the fibrous textile structure of said assembly defining a first fibrous textile structure comprising a porous material having a first density,
wherein the inner lining element further comprising a second fibrous textile structure comprising the same porous material or different porous material, having a second density, the second density being lower than the first density, and
wherein the first and second fibrous textile structures being superimposed.

15. An assembly according to claim 14, wherein:
the second fibrous textile structure has a curved shape and/or reliefs and/or recesses, and
said assembly and the second fibrous textile structure are:
enclosed together in a second closed sleeve comprising one said wall, and
interposed between two major surfaces of said wall, which is thermoformed at said two major surfaces.
